(19) United States
(12) Patent Application Publication
(10) Pub. No.: US 2012/0110303 A1
(43) Pub. Date: May 3, 2012

(54) Method for Process Synchronization of Embedded Applications in Multi-Core Systems

(75) Inventors: Nagashyamala (Nagu) R. Dhanwada, Hopewell Junction, NY (US); Arun Joseph, Bangalore (IN)

(73) Assignee: International Business Machines Corporation, Armonk, NY (US)

(21) Appl. No.: 12/913,880

(22) Filed: Oct. 28, 2010

(51) Int. Cl. G06F 15/76; G06F 9/02; G06F 12/00

(52) U.S. Cl. 712/29; 711/163; 712/31; 711/E12.001; 712/E09.002

(57) ABSTRACT

A system and method for process synchronization in a multi-core computer system. A separate non-caching memory enables a method to synchronize processes executing on multiple processor cores. Since only a very small amount (a few number of bytes), is needed for the synchronization, it is possible to extend the method for inter-processor core message passing by allocating dedicated address space of the on-chip memory for each processor with exclusive write access. Each of the multiple processor cores maintains a dedicated cache while maintaining coherency with the non-cache shared memory.

### FIELD OF THE INVENTION

The present invention relates to efficient utilization of a multi-core processing system and more specifically to an apparatus and method directed to process synchronization of embedded applications in multi-core processing systems while maintaining memory coherency.

### BACKGROUND

The shift toward multi-core processor chips poses challenges to synchronizing the operations running on each core in order to fully utilize the enhanced performance opportunities presented by multi-core processors (e.g., running different applications on different processor cores at the same time and running different operations of the same application on different processor cores). However, present methods of synchronizing operations such as lock/semaphore require atomic instructions (e.g., test-and-set, swap, etc.) or interrupt disabling are difficult to implement and can lead to race conditions, deadlocks and inefficient use of the processors. Accordingly, there exists a need in the art to mitigate the deficiencies and limitations described hereinabove.

### SUMMARY

A first aspect of the present invention is a system for process synchronization in a multi-core computer system, comprising: a primary processor core to control scheduling, completion and synchronization of a plurality of processing threads for the SOC, the primary processor core having a dedicated memory region to facilitate control of processes; a plurality of secondary processor cores each coupled to the primary processor core via address and control line bus architecture, the plurality of secondary processor cores responsive to command inputs from the primary processor core to execute instructions and each having dedicated memory to facilitate control of processes; a first memory wherein the primary processor core and each secondary processors core of the plurality of secondary processor cores have read access to all addresses of said first memory, and wherein write access to the first memory by the primary processor core and each secondary processor core of the plurality of secondary processor cores is restricted to respective address regions; and a switch matrix enabling intra-core communication between the primary processor core and any secondary processor core of the plurality of secondary processor cores and between any pair of secondary processor cores of the plurality of secondary processor cores, according to a pre-defined transmission protocol.

A second aspect of the present invention is a method for process synchronization in a multi-core computer system, comprising: providing a first memory having a dedicated domain for each processor core of a plurality of processor cores, each of the dedicated domains readable by any of the plurality of processor cores; providing a second memory having a dedicated domain for each processor core of a plurality of processor cores; writing a value to an address allocated to a first processor core of the plurality of processor cores in the first memory such that a busy or idle state of the first core may be read by each of the remaining plurality of processor cores; maintaining a value matrix in the second memory for each of the plurality of processor cores enabling a corresponding processor core to monitor the busy and idle states of each of the other processor cores; applying an exclusive ‘OR’ to the value matrix entry for each one of the plurality of processor cores when a busy or idle state of the corresponding one of the plurality of processors changes; and writing the result of the exclusive ‘OR’ operation to a corresponding domain of the first memory to update the status of the corresponding one of the plurality of processor cores.

These and other aspects of the invention are described below.

### BRIEF DESCRIPTION OF THE DRAWINGS

The features of the invention are set forth in the appended claims. The invention itself, however, will be best understood by reference to the following detailed description of an illustrative embodiment when read in conjunction with the accompanying drawings, wherein:

FIG. 1 illustrates a block diagram an exemplary computer system architecture having a multi-core microprocessor according to embodiments of the present invention;

FIG. 2 illustrates the links between processor cores of the multi-core microprocessor system and on-chip memory to provide addressable space for writing, storing and reading set and reset data for each processor core of the multi-core microprocessor architecture according to embodiments of the present invention;

FIG. 3A illustrates the writing of a synchronization signal initiated by a first processor core and subsequent reading of the synchronization signal by a second processor core of the multi-core microprocessor architecture according to embodiments of the present invention;

FIG. 3B illustrates the writing of a synchronization signal initiated by second processor core and subsequent reading of the synchronization signal by the first processor core of FIG. 3A;

FIG. 4A is a flowchart illustrating the steps of writing from dedicated memory to on-chip memory according to embodiments of the present invention;

FIG. 4B is a flowchart illustrating the steps of reading from on-chip memory to dedicated memory according to embodiments of the present invention;

FIG. 5 illustrates a block diagram an exemplary computer system architecture having a multi-core microprocessor distributed on multiple micro-processor chips according to embodiments of the present invention.

### DETAILED DESCRIPTION

The present invention provides a first memory having dedicated write address space for each processor core of a multi-core processor and common read access to all address space by all processor cores. The present invention also provides a multiplicity of processor dedicated second memories that are linked to the first memory. The first and second memories provide a mechanism for indicating synchronization information such as processor status (e.g., busy, idle, error), an event occurrence or an instruction is pending and between which of the multiple processor cores the synchronization information is to be communicated.

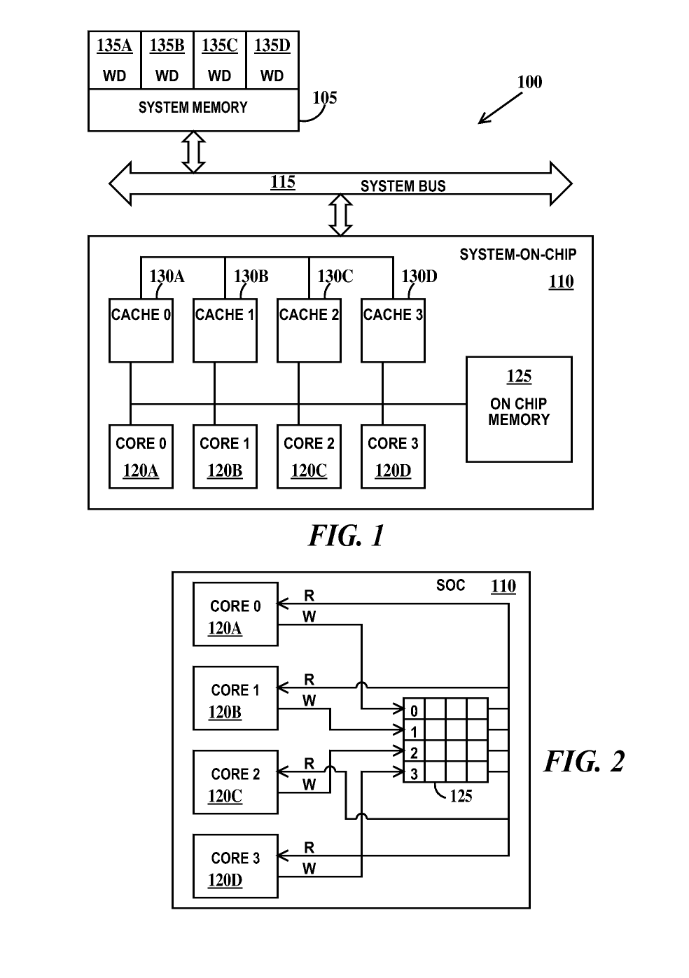

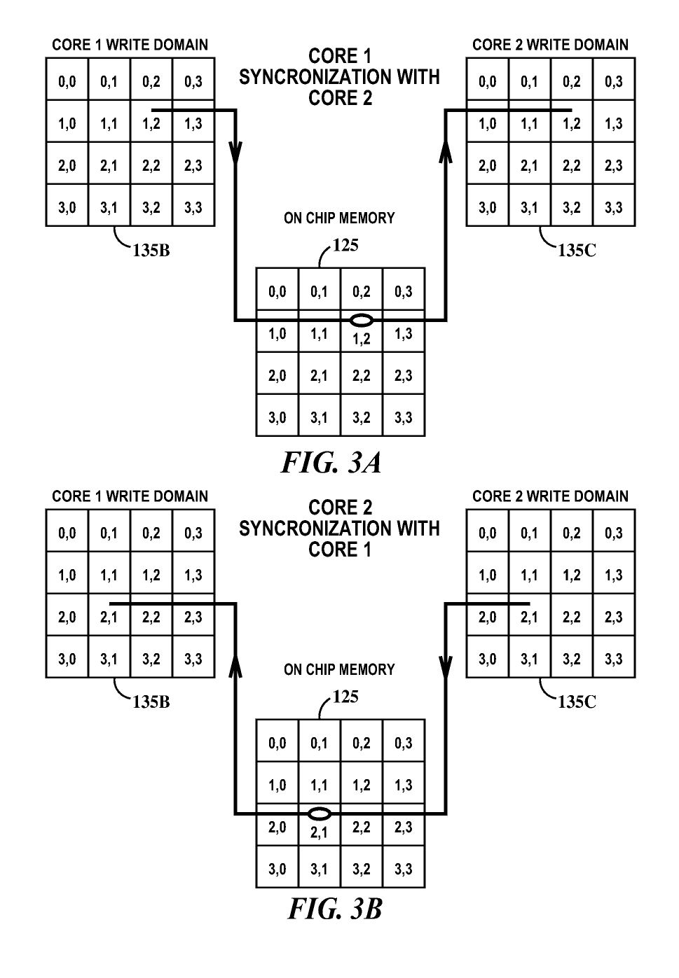

FIG. 1 illustrates a block diagram an exemplary computer system architecture having a multi-core microprocessor according to embodiments of the present invention. In FIG. 1, a computer system 100 includes a system memory 105 and a system-on-chip (SOC) 110 connected to a system bus 115. System bus 115 comprises an address and control line architecture. SOC 110 includes processor core 120A (i.e., core 0), processor core 120B (i.e., core 01), processor core 120C (i.e., core 2), and processor core 120D (i.e., core 3) and an on-chip-memory (OCM) 125. OCM 125 is a shared, non-cache first memory. A shared memory is a memory all processor cores 120A through 120D have read access to, though, as described infra with respect to FIG. 2, there are limitations on the write access for each processor core. Each processor core 120A through 120D is provided with a respective dedicated memory 130A through 130D, either in the system memory or by means of a local memory. A dedicated memory is a memory to which read/write access is limited to a specific core processor. Dedicated memories provide address space to facilitate control of single or multi-threaded processes. Dedicated memories 130A through 130D further include respective dedicated write domains 135A through 135D. Write domains 135A through 135D are second memories dedicated to communication with OCM 125 as illustrated in FIGS. 3A and 3B and described infra.

In one example, processor core 120A is a primary processor core and processor cores 120B, 120C and 120D are secondary processor cores. A primary processor core controls scheduling, completion and synchronization of processing threads on all processor cores to ensure each process has reached a required state before further processing can occur. Secondary processor cores are responsive to command outputs from the primary processor core to execute instructions. Secondary processor cores can also synchronize with each other. Synchronization can be implemented as synchronization points where all secondary processor cores wait for a signal from the primary processor core. On reaching the synchronization point the primary processor core sets the signal to all secondary processor cores and waits for acknowledgement from all the secondary processor cores. On receiving the acknowledgement from the secondary processor cores, the primary processor core instructs the secondary processor core to proceed (e.g., to the next synchronization point).

In one example processor cores 120A, 120B, 120C and 120D are multi-threaded processors. A multithreading processor runs more than one task's instruction stream (thread) at a time. To do so, the processor core has more than one program counter and more than one set of programmable registers. The embodiments of the present invention are applicable to single thread processors and can be extended to multi-threaded processors by treating each thread as a core.

It should be understood that dedicated memories 130A, 130B 130C and 130D and OCM memory need not be physically different memory cores but in one example, partitions of the same memory core. In another example, dedicated memories 130A, 130B, 130C and 130D are partitions of a first memory core and OCM is a second memory core.

FIG. 2 illustrates the links between processor cores of the multi-core microprocessor system and on-chip memory to provide addressable space for writing, storing and reading set and reset data for each processor core of the multi-core microprocessor architecture according to embodiments of the present invention. In FIG. 2, SOC 110 includes cores 120A through 120D and OCM 125. OCM 125 is an m by m array (i.e., a square array of order m) of n-byte address spaces where m is the number of processor cores in the system (in the example of FIG. 2, m=4) n is an integer equal to or greater than 1. Write domains 135A, 135B, 135C and 135D are also m by m arrays (i.e., square arrays of order m) of n-byte address spaces.

Each processor core 120A through 120D can write to only one dedicated (and different row) of OCM 125 while all processor cores 120A through 120D can read all rows of OCM 125. Alternatively, throughout the description of the invention “column” may substituted for all instances of “row” and “row” substituted for all instances of “column.” The lines labeled R and W are implemented as a switch matrix enabling processor core to processor core communication. As described infra, the source of information written to OCM 125 is from write domains 135A through 135D (see FIG. 1). Each row of OCM 125 may be considered a domain allocated to a specific processor core.

FIG. 3A illustrates the writing of a synchronization signal initiated by a first processor core and subsequent reading of the synchronization signal by a second processor core of the multi-core microprocessor architecture according to embodiments of the present invention. In the example of FIG. 3A, processor core 1 (i.e., processor core 130B of FIG. 2) is synchronizing with processor core 2 (i.e., processor core 130C of FIG. 2) using write domains 135B and 135C and OCM 125. As described supra, OCM 125 is an m by m array of n-byte address space where m is the number of processor core of the system (in the example of FIG. 2, m=4) n is an integer equal to or greater than 1. However, write domains are also m by m arrays of n-byte memory addresses. The organization of write domains 135B and 135C (also write domains 135A and 135D, see FIG. 2) and OCM 125 are identical. Each array element of write domains 135B and 135C (also write domains 135A and 135D, see FIG. 2) and OCM 125 represents a unique two processor core combination. There is one array element for each processor core combination. Reading and writing of write domains and OCM is through the processor cores.

In the example of FIG. 3A, rows logically indicate the sending processor core and columns logically indicate the receiving processor core. A row/column intersection defines the send/receive processor core pair as well as which is the sender and which is the receiver. In FIG. 3A core 1 is synchronizing (sending) to core 2. The processor core combination is therefore (1,2) and that array location in all three of write domain 135B, OCM 125 and write domain 135C is used. The data (a synchronization signal) in location (1,2) of write domain 135B is written to location (1,2) of OCM 125 by the processor core to which write domain 135B is dedicated (i.e., processor core 130B of FIG. 2). It will be remembered that each processor core can only write to one row of OCM 125. In FIG. 3A this is row 1 (addresses 1,0; 1,1; 1,2; and 1,3). The data in location (1,2) of OCM 125 is read from location (1,2) of OCM 125 and written to location (1,2) of write domain 135C by the processor core that write domain 135C is dedicated to (i.e., processor core 130C of FIG. 2). It will be remembered that each processor core can read any row of OCM 125. Processor core 130C “knows” the synchronization signal was sent by processor core 130B based on the row and “knows” the synchronization signal is intended for it based on the column. Rows in write domains 135B and 136C may be called value vectors because they represent the current value of the state of the processor core and rows in OCM 125 may be called signal vectors because they are used to signal a toggle of the value of the state of the processor core.

FIG. 3B illustrates the writing of a synchronization signal initiated by second processor core and subsequent reading of the synchronization signal by the first processor core of FIG. 3A. In FIG. 3B core 2 is synchronizing (sending) to core 1. The processor core combination is therefore (2,1) and that array location in all three of write domain 135B, OCM 125 and write domain 135C is used. The data (a synchronization signal) in location (2,1) of write domain 135C is written to location (2,1) of OCM 125 by the processor core 130C (of FIG. 2). It will be remembered that each processor core can only write to one row of OCM 125. In FIG. 3B this is row 2 (addresses 2,0; 2,1; 2,2; and 2,3). The data in location (2,1) of OCM 125 is read from location (2,1) of OCM 125 and written to location (2,1) of write domain 135B by processor core 130C (of FIG. 2). Processor core 130B “knows” the synchronization signal was sent by processor core 130C based on the row and “knows” the synchronization signal is intended for it based on the column.

In the more general case of m processor cores having respective m dedicated write domains (where i=0 to m⁻¹ and j=0 to m⁻¹), when processor core i wants to send a synchronization signal to processor core j it uses the (i,j)^{th} location of the i^{th} write domain and the (i,j)^{th} location of the OCM to do so. After sending the synchronization signal to the OCM, processor core i changes the value (toggles between 0 and 1 if n=1) in the (i,j)^{th} location of write domain (i). Similarly, processor core j waits for the (i,j)^{th} location of the OCM to change from the value currently in the (i,j)^{th} location of the OCM to a different value then currently in the (i,j)^{th} location of write domain (j). When the value changes, this new value is written to the (i,j)^{th} location of write domain (j) overwriting the old value.

When n=1, the synchronization is a two state machine and the synchronization signal is reduced to changing the state of the (i,j)^{th} locations. A powerful use of the present invention in a two state mode (i.e., busy and idle) is the ability of the primary core to know when a secondary processor is idle and then issue instructions for the idle secondary processor to initiate another process. In such a two state system, the primary processor core can direct the timing of the execution of processes on the secondary processor cores by waiting until all secondary processor cores are idle, to ensure processes that must be completed before other processes can start have been completed. In other words, to automatically and quickly detect that a process-synchronization point has been obtained. The secondary processor cores can then be assigned further processes by instructions sent by the primary core processors by normal command routes. When n is greater than 2, then the synchronization is a 2¹¹ state machine. Toggling may be accomplished using an exclusive “OR.” The system is initialized by writing the same value to all (i,j)^{th} locations of all write domains of all dedicated memories and to all (i,j)^{th} locations of the OCM.

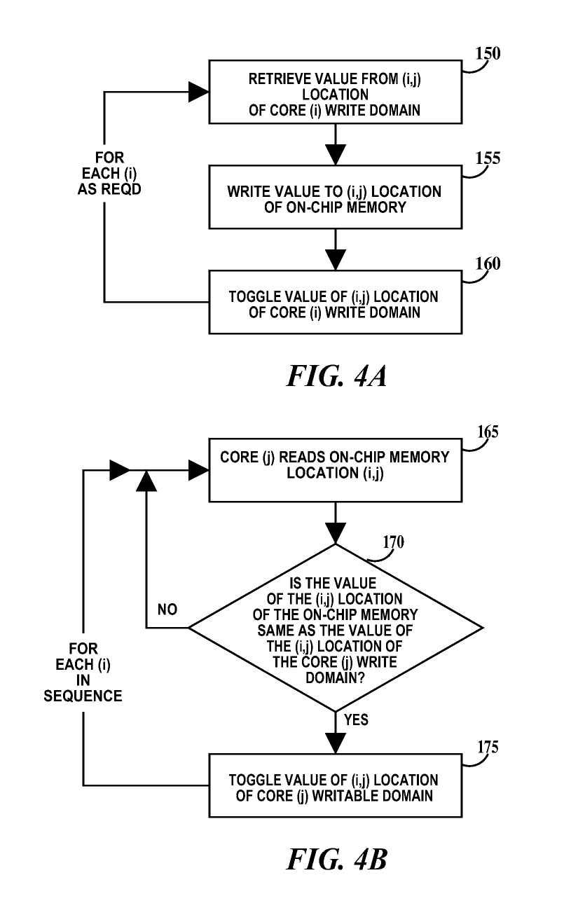

FIG. 4A is a flowchart illustrating the steps of writing from dedicated dedicated memory to on-chip memory according to embodiments of the present invention. In step 150, the value from location (i,j) of dedicated (i) write domain is retrieved. In step 155, the retrieved value is written to the (i,j)^{th} location of the OCM. In step 160, the value in the (i,j)^{th} location of dedicated (i) write domain is toggled. Steps 150, 155 and 160 are part of a larger loop where each core (i) is cycling through all the (j, i) combinations.

FIG. 4B is a flowchart illustrating the steps of reading from on-chip memory to dedicated memory according to embodiments of the present invention. In step 165, core (j) reads OCM location (i,j). In step 170 the value in the (i,j)^{th} location of the OCM is compared to the value in the (i,j)^{th} location of cache (j) write domain. If the two values are the same, then the method proceeds to step 175, otherwise the method loops to step 165. When the values are the same, there is no “message” from the i^{th} processor core for the i^{th} processor core. The loop is back to step 165 so core (j) can sample other (i,j)^{th} locations (i.e., synchronization signals from other processor cores. In other words, steps 165, 170 and 175 are part of a larger loop where each core (j) is cycling through all the (j, i) combinations. In step 175, the value in the (i,j)^{th} location of the dedicated (j) write domain is toggled.

In a general single processor core system, maintaining coherency is the responsibility of the operating system, and the application developer need not worry about that. However, in a multi-processor core system, the developer has to take care of these issues. These issues were studied using a system simulator model for an eight core system-on-chip with 1 MB on-chip non-caching shared memory. Open source GNU (GNU's NOT UNIX) tools for developing embedded PowerPC applications were used for software development. The system was programmed in programming language ‘C’, embedding assembler code for cache related operations.

The model included: (1) Processors are numbered from 0 to (m−1), where m is the number of processors. (2) Processor 0 is the primary processor and the other processors are secondary processors. The master processor performs I/O operations. (3) Programs which are expected to be executed by various processors are loaded in specific ranges of memory as configured in the scripts for the memory loader. (4) Since programs are loaded in specific ranges the processor identification number was obtained by a small routine GetMyid( ). (5) The synchronization signal scheme described in relation to FIGS. 3A, 3B, 4A and 4B. (6) When a number of core processors write the same range of memory the range of memory is declared as write through and invalidating its cache after finishing memory writes, forcing load caching before using the value.

Various routines used are listed and include:

int GetMyid(void)—used by processors to get their process identification (ID) number;

void setsignal(int id)—the processor sets the signal using its processor ID number;

void waitsignal(int id)—a processor waits for a signal from a processor with its processor ID number;

void sync(void)—synchronization mechanism, while processor ID 0 sets the signal, all other processors wait for a signal from processor ID 0. On receiving the signal from processor ID 0, a processor other than processor ID 0 sets a signal to processor ID 0 and processor ID 0 waits for signal from all others processors;

void signaltoproc(int toid)—used by a processor to set a signal for a particular processor;

void waitforproc(int fromid)—used by a processor to wait for a signal from a particular processor;

void checksignal(int fromid)—used by a processor to check whether a signal is ready from processor fromid, but value location is not modified for which a waitforproc(fromid) is needed;

void clearsignals(void)—used by the primary processor to clear the signal locations, before ending the execution. The routine can also be used by a serial program to clear the signal memory before running the real parallel application;

void store Cache(unsigned long addr)—store the cache line which holds the memory address addr;

void invalidate Cache(unsigned long addr)—invalidate the cache line which holds the memory address addr; and

void flushCache(unsigned long addr)—flush the cache line which holds the memory address addr.

On-chip memory was portioned into several sections. The signal vector and matrix was stored in a non-cached on-chip shared memory section starting at address 0xc0000000. (This is memory 125 of FIG. 2). Input matrices were stored in a shared memory at 0x00b00000 and 0x00c00000 respectively, which was configured as cached. An output matrix was allocated a shared memory at address 0x00d00000, which was configured as cached and write through. Programs for processors 0 to 7 were stored in 0x00100000, 0x00200000, 0x0030000, 0x00400000, 0x00500000, 0x00600000, 0x00700000 and 0x00800000. An address mask 0x00f0000 was used by processors to get its processor ID number. Signal values 0xfe and 0xff were used as toggle values for the synchronization signals. The same source code was used to program all processors and each program identified its role from their processor ID numbers.

The programming sequence was: (1) Each processor received its processor ID number. (2) Processor ID 0 initialized the input section stored in OCM and in a separate loop the memory locations were stored to cache memory, so that the OCM was synchronized with cache. Storing was done in a separate loop to avoid storing of already stored cache lines. Then processor ID 0 synchronization signals for all other processors. No explicit cache operations are needed for other processors since the other processors had not yet used any values from OCM (3) All processors computed their share of computation by avoiding frequent reference to a write-through memory. Hence summing was done on a local variable and finally the results were stored in the output section of OCM. (4) Processor ID 0 invalidated the cache value of the output section of OCM, so that further computation loaded the correct value from the OCM.

An unexpected efficiency of the eight processor core system using the architecture of present invention was about 95%. The speed-up of the eight processor core system using the present invention was about 7.5. Speed-up is defined as the ratio of the execution time of a system with one processor core to the execution time of a system with m processor cores. Efficiency is 100 times (Speed-up/m).

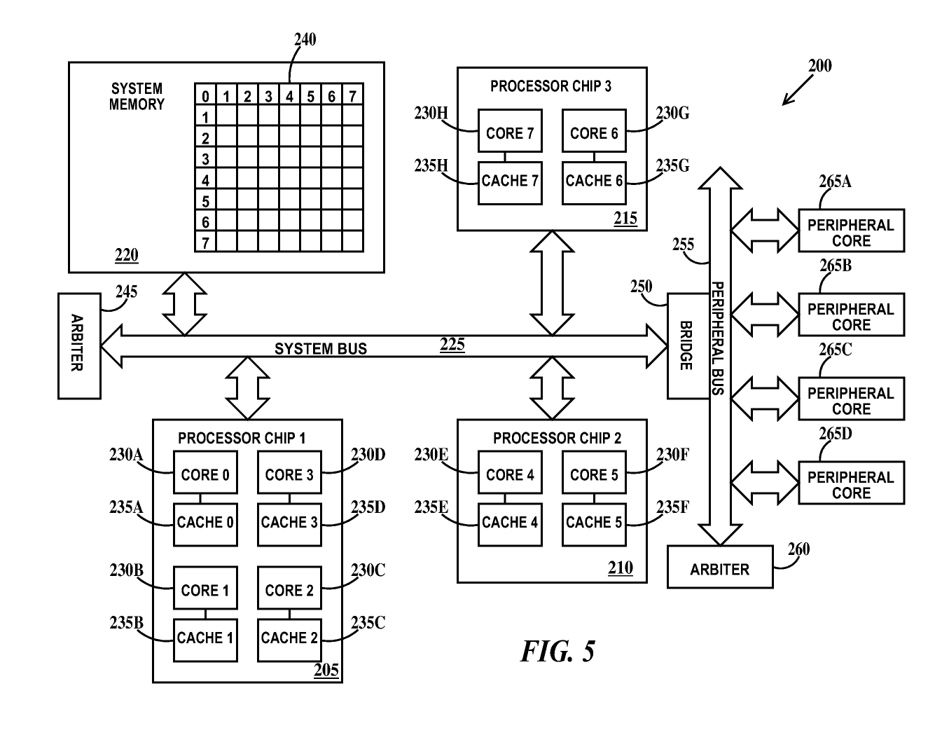

FIG. 5 illustrates a block diagram an exemplary computer system architecture having a multi-core microprocessor distributed on multiple micro-processor chips according to embodiments of the present invention. In FIG. 5, a computer system 200 includes a first processor chip 205, a second processor chip 210 and a third processor chip 215 connected to a system memory 220 by a system bus 225. First processor chip 205 includes processor cores 230A, 230B, 230C and 230D connected to respective caches 235A, 235B, 235C and 235D. Second processor chip 210 includes processor cores 230E and 230F connected to respective caches 235E and 235F. Third processor chip 215 includes processor cores 230G and 230H connected to respective caches 235G and 235H System memory 220 includes a shared non-cacheable memory region 240. Memory region 240 is similar to OCM 125 of FIG. 2 and is configured similarly and supports the same function. However, since computer system 200 is an eight processor core system (m=8) memory region 240 is an 8 by 8 arrays of n-byte memory addresses.

Because the shared memory for the first memory is not on the same chip as the processor cores, there is a performance penalty because of the overhead associated with system bus 225.

Computer system 200 also includes arbiter 245 for arbitrating traffic on system bus 225, a bridge 250 between system bus 225 and a peripheral bus 255, an arbiter 260 for arbitrating traffic on peripheral bus 255, and peripheral cores 265A, 265B, 265C and 265D.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

What is claimed is:

1. A system for process synchronization in a multi-core computer system, comprising:
a primary processor core to control scheduling, completion and synchronization of a plurality of processing threads for the SOC, the primary processor core having a dedicated memory address space to facilitate control of processes;
a plurality of secondary processor cores each coupled to the primary processor core via address and control line bus architecture, the plurality of secondary processor cores responsive to command inputs from the primary processor core to execute instructions and each having dedicated memory address space to facilitate control of processes;
a first memory wherein the primary processor core and each secondary processor core of the plurality of secondary processor cores have read access to all address space of said first memory, and wherein write access to the first memory by the primary processor core and each secondary processor core of the plurality of secondary processor cores is restricted to respective address spaces; and
a switch matrix enabling intra-core communication between the primary processor core and any secondary processor core of the plurality of secondary processor cores and between any pair of secondary processor cores of the plurality of secondary processor according to a pre-defined transmission protocol.

2. The system of claim 1, wherein said primary processor core and each secondary processor core of said plurality of secondary processor cores are multi-thread capable processor cores.

3. The system according to claim 1, wherein a unique identifier is assigned to the primary processor core/thread and to each secondary processor core/thread of the plurality of secondary processor cores.

4. The system according to claim 1, including:
wherein the first memory is configured as a matrix comprising multiple domains;
wherein different domains are allocated to the primary processor core and to each secondary processor core of the plurality of secondary processor cores;
wherein the primary processor core and each secondary processor core of the plurality of secondary processor cores have write access only to their corresponding domains; and
wherein the primary processor core and each secondary processors core of the plurality of secondary processor cores have read access to all domains of said first memory.

5. The system according to claim 1, further comprising a signaling system enabling communication between any of the primary processor core and any of the plurality secondary processor cores, comprising:
a plurality of signal locations with a length equal to the number of processor cores, each of the plurality of signal locations located in corresponding write domains of the first memory;
a plurality of value locations independently maintained by each one of the plurality of processor cores in an associated dedicated memory; and
a two-state state machine to indicate busy and idle states for the primary processor core and each secondary processor core of the plurality of secondary processor cores.

6. The system according to claim 5, further comprising a process synchronization system including the state machine to direct the timing of execution of processes executed by the plurality of secondary cores.

7. The system according to claim 1, wherein the first memory is non-cache memory.

8. The system according to claim 1, wherein the first memory is on the same integrated circuit chip as the primary processor core and the plurality of secondary processor cores.

9. The system according to claim 1, wherein the first memory comprises an m by m array of n-bytes where m is the number of secondary processor cores plus one and n is an integer equal to or greater than one, the primary processor core and each secondary processor core of said plurality of secondary processor cores has write access to a different row of the array, and read access to all rows of said array and wherein row addresses of said first memory are dedicated to data to be sent from a processor core and column addresses of said first memory are dedicated to storing data to be received by a processor core.

10. The system according to claim 9, further including a plurality of second memories each memory of the plurality of second memories comprising an m by m array of n-bytes, each of said second memories being a dedicated write domain of a respective dedicated memory of the primary processor core and each secondary processor core of said plurality of secondary processor cores, and wherein row addresses of said second memory are dedicated to data to be sent from a processor core and column addresses of said second memory are dedicated to storing data to be received by a processor core.

11. A method for process synchronization in a multi-core computer system, comprising:
providing a first memory having a dedicated domain for each processor core of a plurality of processor cores, each of the dedicated domains readable by any of the plurality of processor cores;
providing a second memory having a dedicated domain for each processor core of a plurality of processor cores;
writing a value to an address allocated to a first processor core of the plurality of processor cores in the first memory such that a busy or idle state of the first core may be read by each of the remaining plurality of processor cores;
maintaining a value matrix in the second memory for each of the plurality of processor cores enabling a corresponding processor core to monitor the busy and idle states of each of the other processor cores;
applying an exclusive ‘OR’ to the value matrix entry for each one of the plurality of processor cores when a busy or idle state of the corresponding one of the plurality of processors changes; and
writing the result of the exclusive ‘OR’ operation to a corresponding domain of the first memory to update the status of the corresponding one of the plurality of processor cores.

12. The method according to claim 11, further comprising:
restricting write access to the first memory to a corresponding dedicated domain for each processor core of the plurality of processor cores.

13. The method according to claim 11, further comprising:
configuring one of the plurality of processor cores as a primary processor core, and configuring the remaining processor cores of the plurality of processor cores as secondary processor cores, said primary processor core providing scheduling, monitoring and completion functions for system processes.

14. The method of claim 13, further comprising:
assigning a unique identifier to the primary processor core and respective unique identifiers to said secondary processor cores to facilitate intra-core communication, there being at least one secondary processor core.

15. The method of claim 14, further comprising:
providing a signaling system for communication between the primary processor core and the secondary processor cores;
locating a signal vector of length m, where m equals the number of processor cores in the write domains of the second memory;
maintaining a value vector independently for each of the processor cores in an associated dedicated address space; and
monitoring busy and idle states for each of the plurality of processor cores using a two-state toggling mechanism.

16. The method of claim 15, further comprising:
asserting a signal vector from the primary processor core to each of the secondary processor cores, wherein a signal vector location associated with the primary processor core contains the value from the address specified by the value vector associated with the primary processor core; and
toggling the address specified by the value vector associated with the primary processor core to accept a next value of the signal vector.

17. The method of claim 16, further comprising:
reading a value of the address specified by the signal vector associated with the primary processor core for each of the secondary processor cores and toggling the memory location associated with the value vector corresponding to each one of the secondary processor cores to receive a next signal value.

18. The method of claim 11, wherein when a processor core i wants to send a signal to a processor core j, processor core i sets its signal location j, for which it has exclusive write access, with a value from its value vector location j and toggles the value vector location j to get the value for the next signal.

19. The method of claim 11, including:
wherein the first memory is non-cache memory and comprises an m by m array of n-bytes where m is the number of secondary processor cores plus one and n is an integer equal to or greater than one, the primary processor core and each secondary processor core of said plurality of secondary processor cores has write access to a different row of the array, and read access to all rows of said array and wherein row addresses of said first memory are dedicated to data to be sent from a processor core and column addresses of said first memory are dedicated to storing data to be received by a processor core; and
wherein said second memory comprises plurality of m by m array of n-bytes, each m by m array of said second memories being a dedicated write domain of a respective cache memory of the primary processor core and each secondary processor core of said plurality of secondary processor cores, and wherein row addresses of said second memory are dedicated to data to be sent from a processor core and column addresses of said second memory are dedicated to storing data to be received by a processor core.

20. The method of claim 11, wherein said primary processor core and each secondary processor core are multi-thread capable processor cores.
